(19) United States
(12) Patent Application Publication
(10) Pub. No.: US 2016/0050904 A1
(43) Pub. Date: Feb. 25, 2016

(54) UTILITY CONDUIT COVER

(71) Applicants: Gary Earl TURNER, JR., Summerville, SC (US); Ronald J. SHAFFER, Early Brance, SC (US)

(72) Inventors: Gary Earl TURNER, JR., Summerville, SC (US); Ronald J. SHAFFER, Early Brance, SC (US)

(21) Appl. No.: 14/831,493

(22) Filed: Aug. 20, 2015

Related U.S. Application Data
(60) Provisional application No. 62/039,693, filed on Aug. 20, 2014.

(51) Int. Cl. A01M 29/30; F16L 3/223; E04B 1/72; F16L 3/10

(52) U.S. Cl. CPC A01M 29/30; F16L 3/1091; F16L 3/2235; E04B 1/72

(57) ABSTRACT

A cover apparatus for preventing rodent from entering an access opening of the conduit containing electrical supply lines is provided. The cover apparatus may have a first portion and a second portion, each portion forms a complementary base member defined by a peripheral edge and an operable edge. Along each peripheral edge, a flange member may extend therefrom. Each base member is dimensioned and adapted to be joined so that when joined, they collectively form a shape matching the shape of the access opening, so that the flange members snugly circumscribe the outer periphery of the conduit, while the operable edges abut. Each operable edge forms cooperating notches and protrusions for snugly receiving the plurality of cables. Along the flange member, at each peripheral and operable edge intersection, a fastener tab is formed for securely joining the first and second portions in the operable configuration about the access opening.

### CROSS-REFERENCE TO RELATED APPLICATION

This application claims the benefit of priority of U.S. provisional application No. 62/039,693, filed 20 Aug. 2014, the contents of which are herein incorporated by reference.

### BACKGROUND OF THE INVENTION

The present invention relates to cover apparatus for access openings and, more particularly, to a utility conduit cover for preventing rodent from entering an access opening of the conduit containing electrical supply lines.

Currently, electrical supply lines inside conduits are susceptible to rodent infestations and the destruction they can wreak. Somewhere along a utility conduit there is an access opening from which protrude the electrical supply lines and so where rodent are free to enter the conduit and chew, claw and otherwise damage the electrical supply lines.

As can be seen, there is a need for a utility conduit cover for preventing rodent from entering an access opening of the conduit containing electrical supply lines.

### SUMMARY OF THE INVENTION

In one aspect of the present invention, a cover apparatus for covering an access opening of a cable-containing conduit includes a first portion having a first base member defined by a first peripheral edge and a first operative edge; a first flange member perpendicularly joined along the first peripheral edge; a first fastener tab formed along the first flange member near each of the two intersections of the first peripheral and the first operative edges; a first fastener hole formed through each first fastener tab; and at least one first cooperating notch formed along a portion of the first operative edge, whereby two first portions may be used to cover the access opening of a cable-containing conduit in an operative configuration.

These and other features, aspects and advantages of the present invention will become better understood with reference to the following drawings, description and claims.

### BRIEF DESCRIPTION OF THE DRAWINGS

FIG. 1 is a perspective detail view of an exemplary embodiment of the present invention, shown in use in an operable configuration;

FIG. 2 is a section detail view of an exemplary embodiment of the present invention, taken along line 2-2 in FIG. 1

FIG. 3 is a section detail view of an exemplary embodiment of the present invention, taken along line 3-3 of FIG. 1;

FIG. 4 is a front perspective view of an exemplary embodiment of the present invention;

FIG. 5 is a rear perspective view of an exemplary embodiment of the present invention;

FIG. 6 is a front perspective view of an exemplary embodiment of the present invention;

FIG. 7 is a rear perspective view of an exemplary embodiment of the present invention; and

FIG. 8 is an exploded view of an exemplary embodiment of the present invention, demonstrating formation of the operable configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cover apparatus for preventing rodent from entering an access opening of the conduit containing electrical supply lines. The cover apparatus may have a first portion and a second portion, each portion forms a complementary base member defined by a peripheral edge and an operable edge. Along each peripheral edge, a flange member may extend therefrom. Each base member is dimensioned and adapted to be joined so that when joined, they collectively form a shape matching the shape of the access opening, so that the flange members snugly circumscribe the outer periphery of the conduit, while the operable edges abut. Each operable edge forms cooperating notches and protrusions for snugly receiving the plurality of cables. Along the flange member, at each peripheral and operable edge intersection, a fastener tab is formed for securely joining the first and second portions in the operable configuration about the access opening.

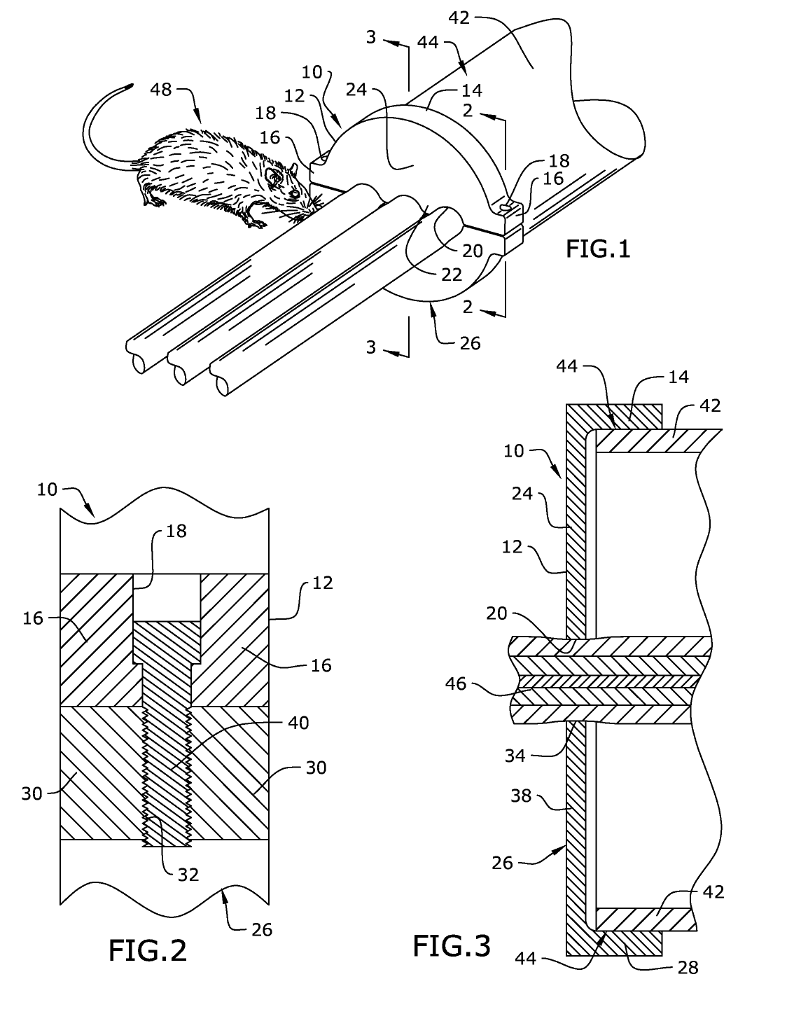

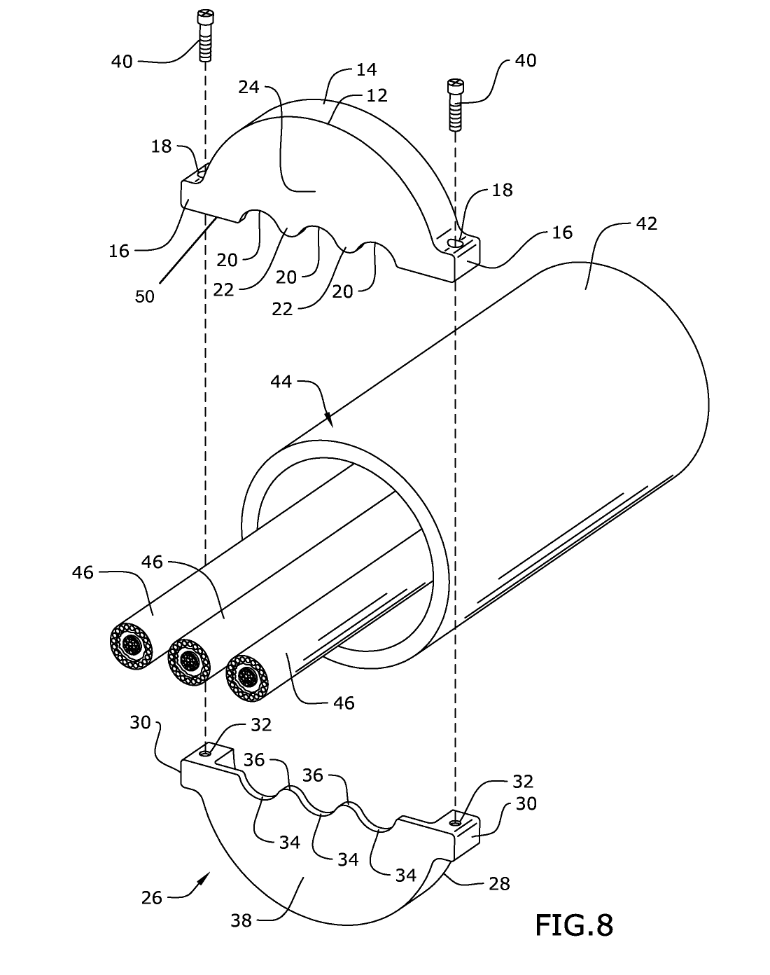

Referring to FIGS. 1 through 8, the present invention may include a cover apparatus 10 having a first portion 12 and a second portion 26 coupled together by a plurality of fasteners 40 so as to seal off an access opening of a conduit 42 from rodents 48, while enabling a plurality of cables 46 to protrude therethrough.

The conduit 42 (or tubular pipe) may have a sidewall 44 forming the access opening, wherein the sidewall 44, in certain embodiments, may be generally annular having an external conduit circumference.

The first portion 12 and the second portion 26 may each have a planar base member 24, 38, respectively, defined by a complementary peripheral edge and an operable edge 50, 52, respectively. The base members 24, 38 may be made of at least one rigid materiel that is dimensioned and adapted so that when both portions 12, 26 are joined in an operable configuration, a shape matching that of the access opening is formed. The shape formed in the operable configuration may have a periphery that is defined by the complementary peripheral edges that are dimensioned to extend beyond an outer periphery of the sidewall 44; for example, if the conduit 42 is cylindrical, then the diameter of a circumferential edge of the operable configuration exceeds the external conduit circumference of the sidewall 44, as illustrated in FIG. 3. The two portions 12, 26 may each be dimensioned to cover approximately half of the access opening. In certain embodiments, the two portions 12, 26 are approximate identical and/or mirror images of each other with respect to substantially most of their components, whereby two first portions may be used to cover the access opening.

Each portion 12, 26 may have a flange member 14, 28, respectively, extending generally perpendicularly from the peripheral edge of each base member 24, 38, along a surface that faces the access opening, as illustrated in FIG. 3. Each flange member 14, 28 may have an interior periphery that exceeds the outer perimeter of the sidewall 44 so that each flange member 14, 28 may be disposed to snugly circumscribe the sidewall 44, as illustrated in FIG. 3.

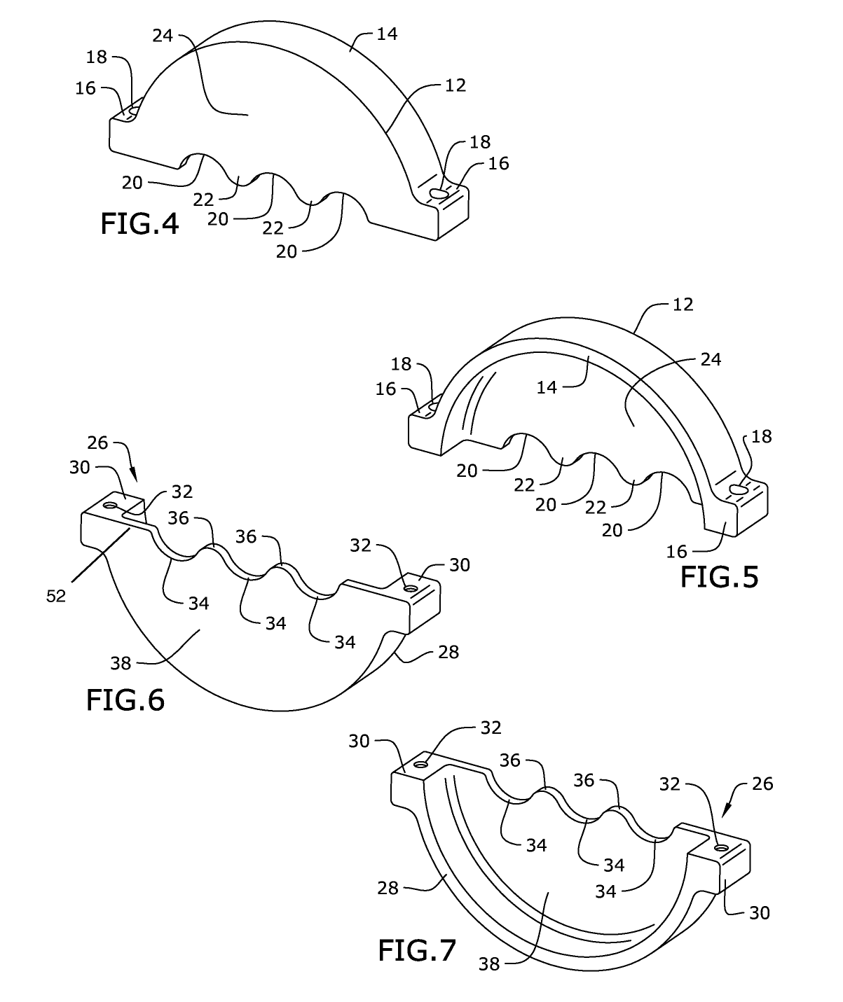

In the operable configuration, the operable edges 50, 52 abut, as illustrated in FIG. 1. A plurality of cooperating notches 20, 34 may be formed along the operable edges 50, 52, respectively. Each cooperating notch 20, 34 may be dimensioned to snugly receive approximately half of a cable 46, wherein cooperating notch 20 complements cooperating notch 34. Each pair of abutting cooperating notches, in the operable configuration, may form an operable notch dimensioned and adapted to slidably receive one of a plurality of cables 46. A cooperating protrusion 22, 36 may be formed along the same operable edges 50, 52 so that each cooperating protrusion 22, 36 spaces apart two adjacent cooperating notches 20, 34, respectively, as illustrated in FIGS. 4-7. Each cooperating protrusion 22, 36 may be dimensioned and adapted to snugly receive a portion of each cable 46. Each cooperating protrusion 22, 36 may be dimensioned to snugly engage a portion of a cable 46, wherein cooperating protrusion 22 complements a cooperating protrusion 36.

Along the flange member, at each peripheral and operable edge intersection, a fastener tab 16 or 30 may be formed: two fastener tabs 16, 30 for the first and second portions 12, 26, respectively, as illustrated in FIGS. 4-7. The first portion fastener tab 16 may form a staggered fastener hole 18, as illustrated in FIG. 2. The second portion fastener tab 16 may form a threaded fastener hole 32 that aligns with it cooperating first fastener hole 18, so that a fastener 40 may interconnect both so as to join the two fastener tabs 16, 30, and so both portions 12, 26 in the operable configuration. In certain embodiments, the fasteners will be threaded, such as screws, so as to securely mate with the threaded fastener holes 32.

In the operable configuration, the access opening is sealed off, yet the plurality of cables 46 protrude through the resulting operable notches, snugly received by the cooperating protrusions 22, 36.

A method of using the present invention may include the following. The cover apparatus 10 disclosed above may be provided. A user may form the operable configuration by operably engaging the flange member 14, 28 of each portion 12, 26 along the outer periphery of the sidewall 44 of the conduit 42 so that the operable edges 50, 52 abut, wherein any cables 46 protruding from the access opening are secured within the resulting operable notches. Then the user may securely join the portions 12, 26 by securing the fasteners 40 in the cooperating tab holes 18, 32, preventing rodents from entering the access opening and damaging the enclosed cables 46 therein.

It should be understood, of course, that the foregoing relates to exemplary embodiments of the invention and that modifications may be made without departing from the spirit and scope of the invention as set forth in the following claims.

What is claimed is:

1. A cover apparatus for covering an access opening of a cable-containing conduit, comprising:
a first portion having a first base member defined by a first peripheral edge and a first operative edge;
a first flange member perpendicularly joined along the first peripheral edge;
a first fastener tab formed along the first flange member near each of the two intersections of the first peripheral and the first operative edges;
a first fastener hole formed through each first fastener tab; and
at least one first cooperating notch formed along a portion of the first operative edge,
whereby two first portions may be used to cover the access opening of a cable-containing conduit in an operative configuration.

2. The cover apparatus of claim 1, wherein the base member is generally semicircular in shape.

3. The cover apparatus of claim 1, further compromising a first cooperating protrusion formed along the first operative edge between adjacent first cooperating notches.

4. The cover apparatus of claim 1, further compromising a second portion comprising:
a base member defined by a second peripheral edge and a second operative edge;
a second flange member perpendicularly joined along the second peripheral edge;
a second fastener tab formed along the second flange member near each of the two intersections of the second peripheral and the second operative edges;
a second fastener hole formed through each second fastener tab; and
at least one second cooperating notch formed along a portion of the second operative edge,
whereby first and second portions may be used to cover the access opening of a cable-containing conduit in the operative configuration.

5. The cover apparatus of claim 4, wherein each second fastener hole is threaded.

6. The cover apparatus of claim 5, wherein each first fastener hole is staggered.

7. The cover apparatus of claim 4, further compromising:
a first cooperating protrusion formed along the first operative edge between adjacent first cooperating notches; and
a second cooperating protrusion formed along the second operative edge between adjacent second cooperating notches,
wherein each first cooperating notch and protrusion has a complementary second cooperating notch and protrusion.

8. The cover apparatus of claim 4, wherein the base member of each portion is generally semicircular in shape.
